(19) United States
(12) Patent Application Publication
(10) Pub. No.: US 2025/0199646 A1
(43) Pub. Date: Jun. 19, 2025

(54) CONTACTLESS INPUT DEVICE

(71) Applicant: Mitsubishi Electric Corporation, Tokyo (JP)

(72) Inventors: Keiichi TSUDA, Tokyo (JP); Hayato KIKUTA, Tokyo (JP); Daichi TSUNEMICHI, Tokyo (JP)

(73) Assignee: Mitsubishi Electric Corporation, Tokyo (JP)

(21) Appl. No.: 18/844,983

(22) PCT Filed: Mar. 24, 2022
(86) PCT No.: PCT/JP2022/013860

§ 371 Date: Sep. 9, 2024

(51) Int. Cl. G06F 3/042; G06F 3/041

(52) U.S. Cl. CPC G06F 3/0425; G06F 3/0418; G06F 2203/04101

(57) ABSTRACT

An contactless input device includes: a three-dimensional-operation-coordinate detecting unit that detects multiple sets of three-dimensional operation coordinates in a predetermined space by sequentially detecting the three-dimensional operation coordinates, which are triaxial coordinates of an instruction input object, which is an object for inputting an instruction; a smoothing processing unit that calculates smoothed three-dimensional operation coordinates by performing smoothing by using a predetermined first number (first number≥2) of sets of three-dimensional operation coordinates included in the multiple sets of three-dimensional operation coordinates; and an aerial-reception-range passage determining unit that specifies passage coordinates, which are coordinates at which the instruction input object passes through a predetermined aerial reception range in the space, by using the smoothed three-dimensional operation coordinates.

### TECHNICAL FIELD

The disclosure relates to a contactless input device and a contactless input method.

### BACKGROUND ART

There are devices that project a real image plane including various input regions such as buttons within a specific range in the air, detects entry of an operating means such as a finger through the plane, and performs various operations in accordance with the coordinates of the point of entry of the operating means (for example, refer to PTL 1).

### PRIOR ART REFERENCE

### Patent Reference

Patent Literature 1: Japanese Patent Application Publication No. 2019-133284

### SUMMARY OF THE INVENTION

### Problem to be Solved by the Invention

However, with conventional techniques, the detected coordinates that indicate operating means include time-varying noise that causes the coordinates to fluctuate in small increments, although the extent of fluctuate depends on the detection principle. Unless this fluctuation is removed, the detection accuracy of the coordinates decreases.

Accordingly, an object of one or more aspects of the disclosure is to remove noise during detection of an operating means while contactless input operation is performed with the operating means, so that the coordinates of the operating means can be detected with high accuracy.

### Means of Solving the Problem

A contactless input device according to an aspect of the disclosure includes: a three-dimensional-operation-coordinate detecting unit configured to detect multiple sets of three-dimensional operation coordinates by sequentially detecting the three-dimensional operation coordinates, the three-dimensional operation coordinates being triaxial coordinates of an instruction input object in a predetermined space, the instruction input object being an object for inputting an instruction; a smoothing processing unit configured to calculate smoothed three-dimensional operation coordinates by performing smoothing by using a predetermined first number of sets of three-dimensional operation coordinates included in the multiple sets of three-dimensional operation coordinates, the first number being two or more; and a passage determining unit configured to specify passage coordinates by using the smoothed three-dimensional operation coordinates, the passage coordinates being coordinates at which the instruction input object passes through an aerial reception range, the aerial reception range being a predetermined range in the space.

A contactless input method according to an aspect of the disclosure includes: detecting multiple sets of three-dimensional operation coordinates by sequentially detecting the three-dimensional operation coordinates, the three-dimensional operation coordinates being triaxial coordinates of instruction object in a an input predetermined space, the instruction input object being an object for inputting an instruction; calculating smoothed three-dimensional operation coordinates by performing smoothing by using a predetermined first number of sets of three-dimensional operation coordinates included in the multiple sets of three-dimensional operation coordinates, the first number being two or more; and specifying passage coordinates by using the smoothed three-dimensional operation coordinates, the passage coordinates being coordinates at which the instruction input object passes through an aerial reception range, the aerial reception range being a predetermined range in the space.

### Effects of the Invention

According to one or more aspects of the disclosure, noise can be removed during detection of an operating means while contactless input operation is performed with the operating means, so that the coordinates of the operating means can be detected with high accuracy.

### BRIEF DESCRIPTION OF THE DRAWINGS

FIG. 1 is a perspective diagram illustrating the exterior of a contactless input device according to first to fourth embodiments.

FIG. 2 is a block diagram schematically illustrating a configuration of the contactless input device according to the first to third embodiments.

FIGS. 3A to 3D are schematic diagrams for explaining a method of detecting the three-dimensional operation coordinates.

FIG. 4 is a schematic diagram for explaining a camera coordinate system.

FIG. 5 is a schematic diagram for explaining the correspondence between the camera coordinate system and the aerial-reception-range coordinate system.

FIGS. 6A and 6B are block diagrams illustrating hardware configuration examples.

FIG. 7 is a flowchart illustrating the operation of determining whether an instruction input object has passed through an aerial reception range in the first embodiment.

FIGS. 8A to 8C are graphs for explaining in detail the differences between passage determination and coordinate determination.

FIG. 9A to 9C are graphs for explaining values for passage determination and coordinate determination.

FIG. 10 is a perspective diagram for explaining an aerial reception range.

FIG. 11 is a flowchart illustrating the operation of specifying a process in response to input to an aerial reception range.

FIG. 12 is a graph for explaining a situation in which chattering occurs.

FIG. 13 is a graph for explaining a method of eliminate chattering.

FIG. 14 is a schematic diagram illustrating a projected image in the second embodiment.

FIG. 15 is a cross-sectional diagram of an aerial reception range according to the second embodiment and its the vicinity taken along a plane perpendicular to the y-axis.

FIG. 16 is a flowchart illustrating the operation of determining whether an instruction input object has passed through an aerial reception range in the second embodiment.

FIG. 17 is a schematic diagram illustrating a modification of the aerial reception range according to the second embodiment.

FIGS. 18A to 18C are graphs for explaining in detail the operation of the aerial-reception-range passage determining unit according to the third embodiment.

FIGS. 19A and 19B are schematic diagrams illustrating a configuration of a two-stage cascade type IIR filter.

FIG. 0 is a graph illustrating group delay characteristics of a two-stage cascade IIR filter.

FIG. 21 is a block diagram schematically illustrating a configuration of the contactless input device according to the fourth embodiment.

FIG. 22 is a flowchart illustrating the operation of determining whether an instruction input object has passed through an aerial reception range in the fourth embodiment.

FIGS. 23A to 23C are graphs for explaining the operation of the aerial-reception-range passage determining unit.

### MODE FOR CARRYING OUT THE INVENTION

### First Embodiment

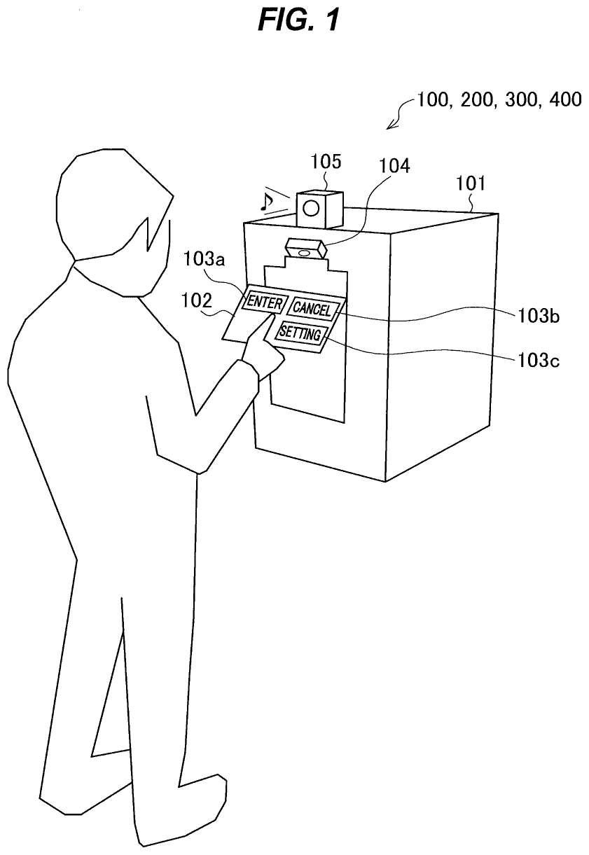

FIG. 1 is a perspective diagram illustrating the exterior of a contactless input device 100 according to the first embodiment.

The contactless input device 100 uses a mechanism mounted inside a housing 101 to project an aerial image 102 into a predetermined space. Since a known technique may be used for the mechanism projecting the aerial image 102, a detailed explanation thereof is omitted. According to a known technique, for example, a display is mounted inside the housing 101, and a retroreflective material and a half mirror can be used to re-focus the light emitted from the display into the air to project an aerial image 102. As the mechanism for such projection, an alternate means may be used.

Buttons 103a, 103b, and 103c, which are aerial input reception planes, are displayed in the aerial image 102. The buttons 103a, 103b, and 103c are assigned instructions for the contactless input device 100. Here, an “enter” instruction is assigned to the button 103a, a “cancel” instruction is assigned to the button 103b, and a “setting” instruction is assigned to the button 103c.

When there is no need to distinguish between the buttons 103a, 103b, and 103c, any one of the buttons 103a, 103b, and 103c is referred to as “button 103.”

The buttons 103a, 103b, and 103c are each associated with an aerial reception range that accepts input of an instruction from a user. For example, when an instruction input object, such as a finger, enters the aerial reception range associated with the button 103a, the contactless input device that 100 determines an instruction corresponding to the content assigned to the button 103a has been inputted. An instruction input object is an object for inputting an instruction and is used for inputting an instruction. For example, an instruction input object is a finger or a protrusion such as a rod.

The aerial reception range may be a portion of the aerial image 102. The aerial reception range does not have to coincide with the button 103 presented in the aerial image 102, such as in the cases of the aerial reception range being offset from the corresponding button 103, being tilted from the corresponding button 103, or being bent relative to the corresponding button 103. Moreover, the aerial reception range may be a flat or curved plane, or a three-dimensional shape with thickness, e.g., a cuboid or sphere.

A user of the contactless input device 100 issues an instruction to the contactless input device 100 by inserting an instruction input object, such as a finger, into the aerial reception range associated with the button 103 corresponding to the content of the instruction. Whether the instruction input object has entered the aerial reception range is detected by using an image camera 104 mounted on the housing 101 of the contactless input device 100 and having an imaging range containing the aerial reception range associated with the buttons 103a, 103b, and 103c.

The image camera 104 is a detection device capable of capturing three-dimensional images. The image camera 104 is, for example, a three-dimensional camera using a time of flight (TOF) system. However, a TOF three-dimensional camera is a mere example, and the image camera 104 may be any detection device that can acquire three-dimensional information, e.g., a binocular stereo camera, an active stereo camera, LiDAR, etc.

The contactless input device 100 outputs an operation reception sound from a speaker 105 as feedback to the user issuing an instruction. In the first embodiment, feedback is provided by sound, but this is a mere example; alternatively, feedback may be provided by, for example, simulated tactile sensations or the like provided by light, vibration, or radiating ultrasonic waves to a finger, or a combination of these sensations.

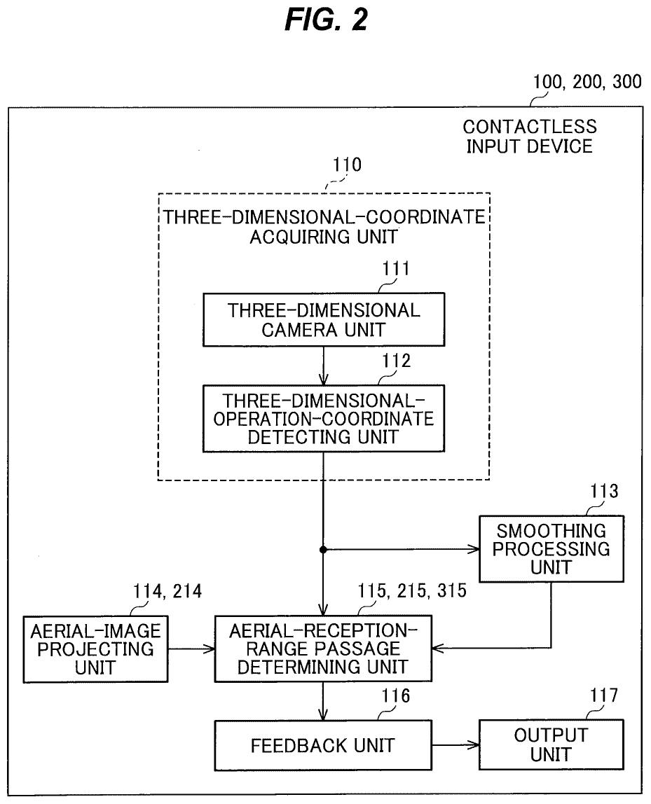

FIG. 2 is a block diagram schematically illustrating a configuration of the contactless input device 100 according to the first embodiment.

The contactless input device 100 includes a three-dimensional-coordinate acquiring unit 110, a smoothing processing unit 113, an aerial-image projecting unit 114, an aerial-reception-range passage determining unit 115, a feedback unit 116, and an output unit 117.

The three-dimensional-coordinate acquiring unit 110 acquires three-dimensional operation coordinates, which are three-dimensional coordinates of an instruction input object.

The three-dimensional-coordinate acquiring unit 110 includes a three-dimensional camera unit 111 and a three-dimensional-operation-coordinate detecting unit 112.

The three-dimensional camera unit 111 is a functional part implemented by the image camera 104 in FIG. 1. The three-dimensional camera unit 111 captures a three-dimensional image IM and gives it to the three-dimensional-operation-coordinate detecting unit 112.

In specific, the three-dimensional camera unit 111 outputs a three-dimensional image IM that is a three-dimensional image of a predetermined space containing an aerial image projected by the aerial-image projecting unit 114, as described later.

The three-dimensional-operation-coordinate detecting unit 112 detects the triaxial coordinates of an instruction input object, or three-dimensional operation coordinates C, from the three-dimensional image IM.

Here, the three-dimensional-operation-coordinate detecting unit 112 detects multiple sets of three-dimensional operation coordinates C of different time points by sequentially detecting the three-dimensional operation coordinates C of the instruction input object.

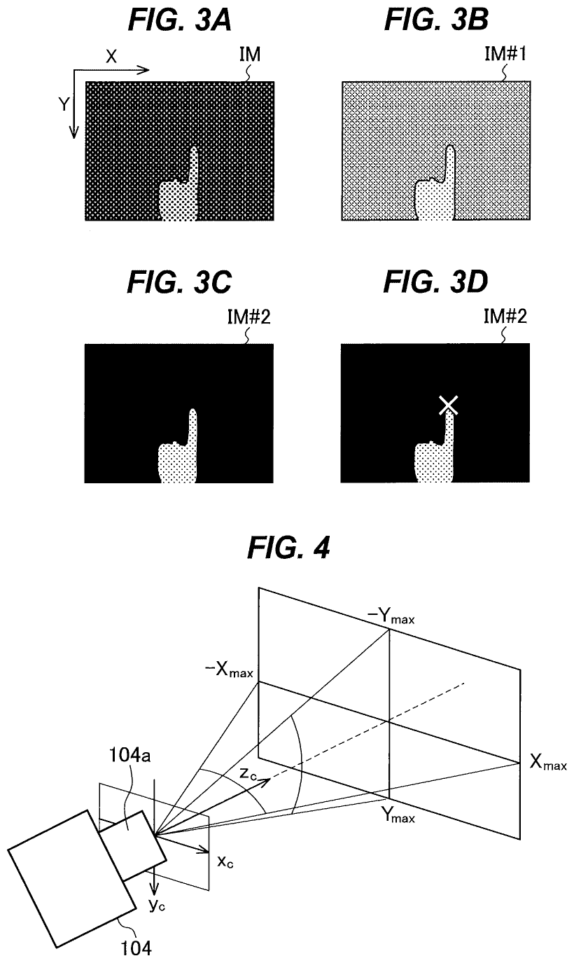

FIGS. 3A to 3D are schematic diagrams for explaining a method of detecting the three-dimensional operation coordinates C.

FIG. 3A illustrates a three-dimensional image IM. It is assumed that the three-dimensional image IM here is defined by the horizontal axis X and the vertical axis Y, and is a distance image in which the pixel intensity represents the distance from the image camera 104. In the three-dimensional image IM, distance is represented by the brightness of pixels such that pixels with higher brightness are closer to the image camera 104.

FIG. 3B illustrates a binarized three-dimensional image IM #1 generated by binarizing the three-dimensional image IM illustrated in FIG. 3A.

The three-dimensional-operation-coordinate detecting 112 unit generates the binarized three-dimensional image IM #1 by binarizing the three-dimensional image IM. Binarization is performed to distinguish between points of an instruction input object, such as a finger, and other points. Therefore, it is assumed that a threshold is determined so that the points can be distinguished appropriately. For example, when the image camera 104 is installed downward, as illustrated in FIG. 1, a threshold is preferably set to a value farther than the furthest end of the aerial reception range corresponding to each of the buttons 103a, 103b, and 103c and closer to the ground.

The three-dimensional-operation-coordinate detecting unit 112 then removes noise from the binarized three-dimensional image IM #1 to generate a denoised three-dimensional image IM #2.

FIG. 3C is a schematic diagram illustrating the denoised three-dimensional image IM #2.

Distance images generally have relatively high noise. Therefore, a lot of fine noise is included in the binarized three-dimensional image IM #1 in FIG. 3B. The three-dimensional-operation-coordinate detecting unit 112 removes such noise by increasing the minimum area to be detected as a closed domain to some extent, to generate the denoised three-dimensional image IM #2 illustrated in FIG. 3C. It is possible to apply various other noise removal methods, such as methods using median filters or methods for performing opening after closing.

The three-dimensional-operation-coordinate detecting unit 112 then detects the tip of the finger that is an instruction input object in the denoised three-dimensional image IM #2, as illustrated in FIG. 3D. Here, the negative direction along the Y-axis of the aerial plane is defined as a direction toward the user, and the positive direction along the Y-axis is a direction toward the housing 101. Since the finger enters from the negative side into the positive side along the Y axis, the tip of the finger is simply the point having the smallest Y-axis coordinate in the detected closed domain. In FIG. 3D, this point is indicated by a cross.

In this way, the X and Y coordinates of the tip point are determined. Since the distance to this point is equal to depth Z obtained from the brightness of the pixel (X, Y) in the original three-dimensional image IM, the three-dimensional coordinates (X, Y, Z) of the point are determined.

The three-dimensional-operation-coordinate detecting unit 112 then expresses the three-dimensional coordinates (X, Y, Z) in a camera coordinate system, which is a coordinate system with the three-dimensional camera unit 111 at the origin. As illustrated in FIG. 4, the camera coordinate system is a coordinate system in which the tip of the optical axis of a lens 104a of the image camera 104 serving as the three-dimensional camera unit 111 is defined as the origin, the long axis side as the x_{c}-axis, the short axis side the y-axis, and the optical axis as the z_{c}-axis. In a typical non-telecentric optical system, the imaging area spreads radially, so when the Z coordinate varies relative to a constant X or Y coordinate, the value of x_{c} of y_{c} Varies.

As illustrated in FIG. 4, when the horizontal angle of view is α, the vertical angle of view is β, the range of X is (−Xₘₐₓ, Xₘₐₓ), and the range of Y is (−Yₘₐₓ, Yₘₐₓ), the three-dimensional coordinates (X, Y, Z), which are the coordinates of the fingertip in the captured image, can be transformed to image-based three-dimensional coordinates (x_{c}, y_{c}, z_{c}), which are coordinates of the camera coordinate system, by the following equation (1).

$$( \begin{matrix}{x}_{c} \\ {y}_{c} \\ {z}_{c}\end{matrix} ) = ( \begin{matrix}\frac{X Z}{{X}_{max}} tan \frac{α}{2} \\ \frac{Y Z}{{Y}_{max}} tan \frac{β}{2} \\ Z\end{matrix} ) \qquad ( 1 )$$

The transformation method to obtain the image-based three-dimensional coordinates as described above is an example, and various other methods can be applied, such as pattern matching or methods using learning machines.

The image-based three-dimensional coordinates (x_{c}, y_{c}, z_{c}) obtained in this way require further transformation when the camera coordinate system differs from the coordinate system of the aerial reception range. This is defined as transformation of image-based three-dimensional coordinates (x_{c}, y_{c}, z_{c}) of a camera coordinate system into three-dimensional operation coordinates C of an aerial-reception-range coordinate system having an x-axis, a y-axis, and a z-axis.

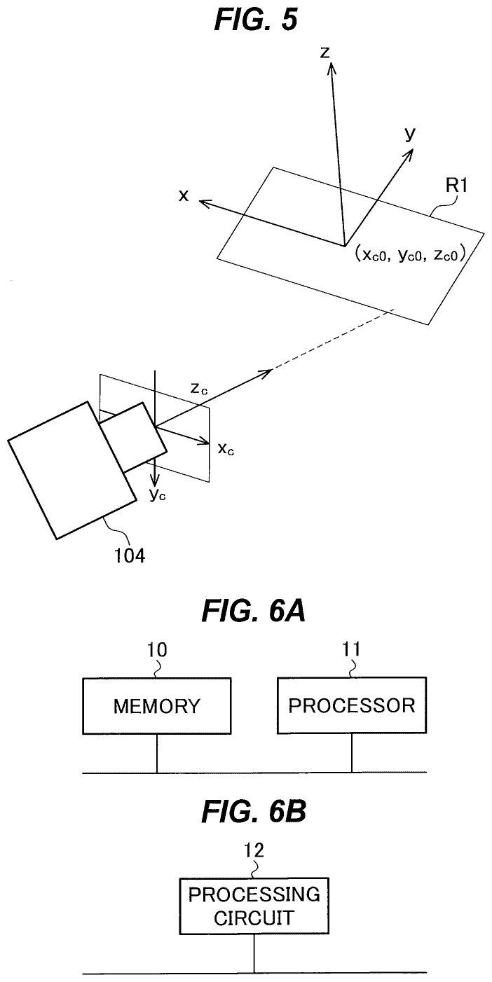

FIG. 5 is a schematic diagram for explaining the correspondence between the camera coordinate system and the aerial-reception-range coordinate system.

The transformation is performed an equal number of times as the number of aerial reception ranges R, but in FIG. 5, only one aerial reception range R1 is illustrated for ease of explanation.

In FIG. 5, as a specific example, the aerial reception range R1 linked to a certain button 103 is (|x|<xₘₐₓ, |y|<yₘₐₓ, z=0). The image-based three-dimensional coordinates (x_{c}, y_{c}, z_{c}) can be transformed into three-dimensional operation coordinates C (x, y, z) of the aerial-reception-range coordinate system by using the following expression (2), where the origin of the aerial-reception-range coordinate system is (x_{c0}, y_{c0}, z_{c0}), rotation around the x_{c}-axis is θ, rotation around the y_{c}-axis is ψ, and rotation around the z_{c}-axis is φ.

$$( 2 )$$

$$( \begin{matrix}x \\ y \\ z\end{matrix} ) = ( \begin{matrix}cos ϕ & - sin ϕ & 0 \\ sin ϕ & cos ϕ & 0 \\ 0 & 0 & 1\end{matrix} ) ( \begin{matrix}cos ψ & 0 & sin ψ \\ 0 & 1 & 0 \\ - s in ψ & 0 & cos ψ\end{matrix} ) ( \begin{matrix}1 & 0 & 0 \\ 0 & cos θ & - s in θ \\ 0 & sin θ & cos θ\end{matrix} ) ( \begin{matrix}{x}_{c} - {x}_{c 0} \\ {y}_{c} - {y}_{c 0} \\ {z}_{c} - {z}_{c 0}\end{matrix} )$$

The transformation from the camera coordinate system to the aerial-reception-range coordinate system needs to be performed for each aerial reception range R as mentioned above, but by defining a common normal direction for the aerial reception ranges R, expensive rotation calculations can be shared, and the amount of computation can also be reduced.

Referring back to FIG. 2, the smoothing processing unit 113 calculates smoothed three-dimensional operation coordinates SC through smoothing using a predetermined first number of sets (first number ≥2) of three-dimensional operation coordinates C out of the multiple sets of three-dimensional operation coordinates C.

For example, the smoothing processing unit 113 smooths the three-dimensional operation coordinates C in the direction of time and gives the results to the aerial-reception-range passage determining unit 115 as smoothed three-dimensional operation coordinates SC. The smoothing method in the present embodiment uses a seven-tap moving average for smoothing. The smoothing processing unit 113 calculates the smoothed three-dimensional operation coordinates SC by using the following expression (3), where (x, y, z) at a time point t is x(t), y(t), and z (t).

$$( \begin{matrix}\tilde{x} ( t ) \\ \tilde{y} ( t ) \\ \tilde{z} ( t )\end{matrix} ) = ( \begin{matrix}\frac{1}{7} {\sum }_{k = 0}^{6} x ( t - k ) \\ \frac{1}{7} {\sum }_{k = 0}^{6} y ( t - k ) \\ \frac{1}{7} {\sum }_{k = 0}^{6} z ( t - k )\end{matrix} ) \qquad ( 3 )$$

In the present embodiment, a moving average filter is used as a means of smoothing, but the present embodiment is not limited to such an example. Various means can be applied as smoothing filters, such as means using finite impulse response (FIR) digital filters or infinite impulse response (IIR) digital filters with different coefficients of a window function method or the like.

The aerial-image projecting unit 114 projects, into a predetermined space, an aerial image having portions associated with aerial reception ranges. For example, the aerial-image projecting unit 114 projects an aerial image 102, as illustrated in FIG. 1. In the aerial image 102, the portions associated with the aerial reception ranges are buttons 130a to 130c. As for the technique for projecting aerial images, a well-known technique may be used.

Here, the aerial-image projecting unit 114 gives aerial reception range information indicating an aerial reception range R in the aerial-reception-range coordinate system to the aerial-reception-range passage determining unit 115.

The aerial-reception-range passage determining unit 115 is a passage determining unit that determines whether a finger, which is an example of an instruction input object, has passed through an aerial reception range R on the basis of three-dimensional operation coordinates C and the aerial reception range R indicated by aerial reception range information from the aerial-image projecting unit 114. The aerial-reception-range passage determining unit 115 then gives a passage determination result P indicating the determined result to the feedback unit 116.

Here, the aerial-reception-range passage determining unit 115 determines whether the instruction input object has passed through the aerial reception range R by using a function predetermined such that the output of the function that takes the three-dimensional operation coordinates C as input is a predetermined value in the aerial reception range R. For example, the aerial-reception-range passage determining unit 115 sequentially inputs multiple sets of three-dimensional operation coordinates to the function, and when an output of the function becomes larger or smaller than the predetermined value, the aerial-reception-range passage determining unit 115 can determine whether the instruction input object has passed through the aerial reception range R.

In specific, the aerial-reception-range passage determining unit 115 establishes a function f(x,y,z) where points in the aerial reception range R satisfy f(x,y,z)=0. In this way, when f(x,y,z) transitions from positive to negative or vice versa, it always passes through the aerial reception range R established as f(x,y,z)=0. Thus, the aerial-reception-range passage determining unit 115 can determine whether an instruction input object has passed through an aerial reception range by confirming the value of f(x,y,z) to which the three-dimensional operation coordinates C have been inputted, in other words, by using the three-dimensional operation coordinates C.

The first embodiment is described by assuming that the aerial reception range R is a plane where f(x,y,z)=z.

The aerial-reception-range passage determining unit 115 also specifies passage coordinates, which are coordinates at which the instruction input object has passed through the aerial reception range R by using smoothed three-dimensional operation coordinates SC.

In specific, the aerial-reception-range passage determining unit 115 specifies passage coordinates CSC indicating through which coordinates a finger, or an instruction input object, has passed through the aerial reception range R on the basis of the smoothed three-dimensional operation coordinates SC from the smoothing processing unit 113.

Here, the passage coordinates CSC are composed of the x-axis value and the y-axis value obtained from the above expression (3) for a time point t at which a finger, which is an example of an instruction input object, is determined to have passed through the aerial reception of three-dimensional operation range R on the basis coordinates C.

Furthermore, when the specified passage coordinates CSC are within the aerial reception range R, the aerial-reception-range passage determining unit 115 determines that the instruction input object has passed through the aerial reception range R, in other words, input has been made to the aerial reception range R.

For example, the aerial-reception-range passage determining unit 115 specifies the value of the first axis extending in a direction intersecting the aerial reception range R among the three axes from the three-dimensional operation coordinates C. The aerial-reception-range passage determining unit 115 uses the specified value to specify the time point at which the instruction input object has passed through the aerial reception range R. The aerial-reception-range passage determining unit 115 specifies the values of the second and third axes, which are two of the three axes (excluding the first axis), of the specified time point as passage coordinates CSC on the basis of smoothed the three-dimensional operation coordinates SC. When the passage coordinates CSC are within the aerial reception range R, the aerial-reception-range passage determining unit 115 determines that input has been made to the aerial reception range R. Here, the first axis is the z-axis, the second axis is the x-axis, and the third axis is the y-axis.

The feedback unit 116 refers to the passage determination result P and provides feedback when the determination is true, in other words, when the determination indicates that the instruction input object has passed through the aerial reception range R. In specific, the feedback unit 116 outputs, for example, an operation reception sound from the output unit 117 serving as the speaker 105.

The output unit 117 provides output to outside of the contactless input device 100 in response to an instruction from the feedback unit 116. The feedback unit 116 issues an instruction when an instruction input object passes through the aerial reception range R.

Here, the output unit 117 outputs feedback to the user. For example, when the output unit 117 is the speaker 105 illustrated in FIG. 1, the output unit 117 outputs an operation reception sound.

The output unit 117 is not limited to the speaker 105 that outputs sound, and may be another means such as a display. Alternatively, the output unit 117 may output ultrasonic waves that provide tactile sensation to the instruction input object.

Some or all of the three-dimensional-operation-coordinate detecting unit 112, the smoothing processing unit 113, the aerial-reception-range passage determining unit 115, and the feedback unit 116 described above can be implemented by, for example, a memory 10 and a processor 11 such as a central processing unit (CPU) that executes programs stored in the memory 10, as illustrated in FIG. 6A. Such programs may be provided over a network or may be recorded and provided on a recording medium. That is, such programs may be provided, for example, as a program product.

Some or all of the three-dimensional-operation-coordinate detecting unit 112, the smoothing processing unit 113, the aerial-reception-range passage determining unit 115, and the feedback unit 116 can also be implemented by, for example, a single circuit, a composite circuit, a processor operated by a program, a parallel processor operated by a program, a processing circuit 12 such as an application specific integrated circuit (ASIC) or a field programmable gate array (FPGA), as illustrated in FIG. 6B.

As described above, the three-dimensional-operation-coordinate detecting unit 112, the smoothing processing unit 113, the aerial-reception-range passage determining unit 115, and the feedback unit 116 can be implemented by processing circuitry.

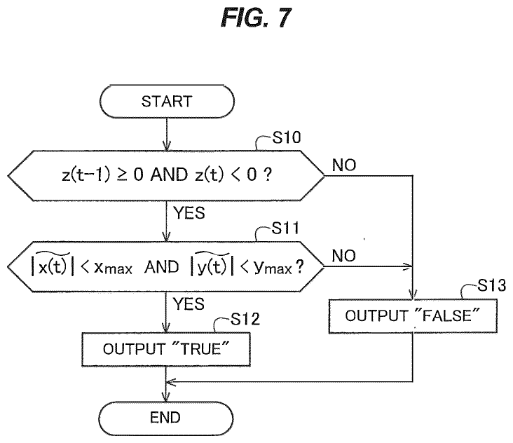

FIG. 7 is a flowchart illustrating the operation of determining whether an instruction input object has passed through an aerial reception range R in the first embodiment. Here, the aerial reception range R is assumed to be an aerial reception range R1 (|x|<xₘₐₓ, |y|<yₘₐₓ, z=0), such as that illustrated in FIG. 5.

First, the aerial-reception-range passage determining unit 115 determines whether z(t−1), which is the z coordinate value of the three-dimensional operation coordinates C at a time point t−1, is positive or zero, and whether z(t), which is the z coordinate value of the three-dimensional operation coordinates C at a time point t, is negative (step S10).

When the frame rate is 30 frames per second, the time difference between the time point t−1 and the time point t is equivalent to one frame, or 1/30 seconds.

Such determination is performed because instruction is inputted when an instruction input object passes through the aerial reception range R1 from upper side to the lower side, wherein the origin of the aerial-reception-range coordinate system is provided in the aerial reception range R1, as illustrated in FIG. 5, and the upward direction along a line perpendicular to the aerial reception range R1 is positive. Thus, the aerial reception range R1 is a plane where z=0.

This corresponds to a so-called fall in z(t). What is important to note here is that the values used for the determination are the three-dimensional operation coordinates C, which are pre-smoothing values. The three-dimensional operation coordinates C are used because the smoothed three-dimensional operation coordinates SC are delayed to compensate for reduction in error; therefore, if the smoothed three-dimensional operation coordinates SC are used, the determination is also delayed. The three-dimensional operation coordinates C are used here because immediate responsiveness in the performance of the device is important.

Next, the aerial-reception-range passage determining unit 115 determines whether the passage coordinates CSC, which are smoothed x and y coordinate values of the smoothed three-dimensional operation coordinates SC at the time point t, satisfy expressions (4) and (5) below (step S11).

$$\vert \vert < {x}_{max} \qquad ( 4 )$$

$$\vert \vert < {y}_{max} \qquad ( 5 )$$

If both expressions (4) and (5) are satisfied (Yes in step S11), the process proceeds to step S12, and if at least one of expressions (4) and (5) is not satisfied (No in step S11), the process proceeds to step S13.

In step S12, the aerial-reception-range passage determining unit 115 determines that the instruction input object has passed through a target aerial reception range R.

Meanwhile, in step S13, the aerial-reception-range passage determining unit 115 determines that the instruction input object has not passed through a target aerial reception range R.

When multiple aerial reception ranges R are provided, the aerial-reception-range passage determining unit 115 can specify through which aerial reception range R the instruction input object has passed by executing the above flowchart for every aerial reception range R.

Here, in step S11, it is determined whether the smoothed three-dimensional operation coordinates SC are within an aerial reception range R. The determination of this step specifies, for example, which button 103 on the screen has been pressed, and in order to increase actual resolution, it is necessary to use smoothed three-dimensional operation coordinates SC, which are high-precision coordinates. Delay arises as a consequence of such use; however, in reality, some delay is not a problem because it is known that when a user of the contactless input device 100 such as that in the present embodiment operates a button 103 in the air, the user has a tendency to move their finger in a direction perpendicular to the button 103, and when the finger moves in this direction, the x and y coordinates are substantially constant.

As described above, different smoothing strategies are effective for determination of passage and determination of coordinates because passage determination is binary determination, determination of the passing or not passing, while coordinate determination is a multivalued determination where there are variations in the determination results depending on the number of coordinates on the screen.

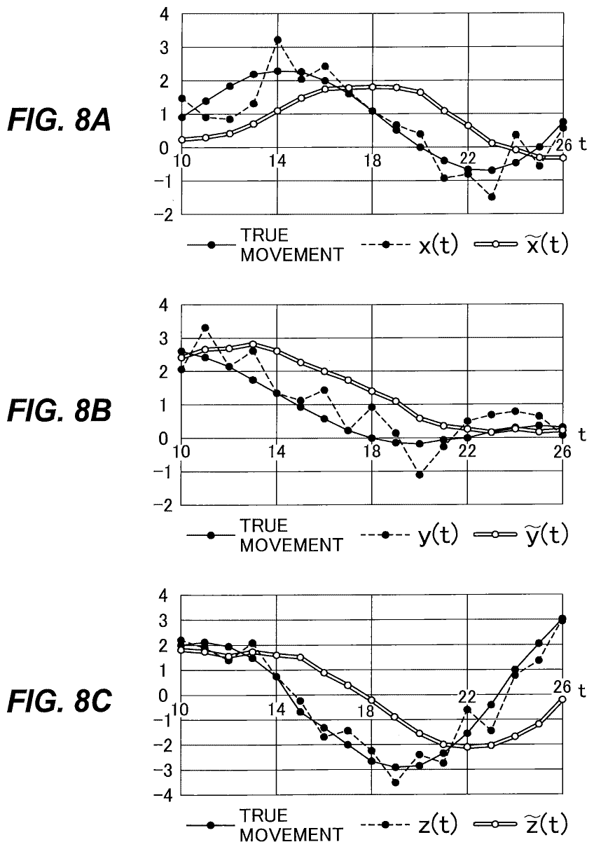

FIGS. 8A to 8C are graphs for explaining in detail the differences between passage determination and coordinate determination, as described above.

FIG. 8A is a graph illustrating a time series of the x-axis value of actual finger movement in an aerial-reception-range coordinate system, the x-axis value of three-dimensional operation coordinates C, and the x-axis value of smoothed three-dimensional operation coordinates SC. The horizontal axis of FIG. 8A represents time, and the vertical axis represents x-axis values.

FIG. 8B is a graph illustrating a time series of the y-axis value of actual finger movement in an aerial-reception-range coordinate system, the y-axis value of the three-dimensional operation coordinates C, and the y-axis value of the smoothed three-dimensional operation coordinates SC. The horizontal axis of FIG. 8B represents time, and the vertical axis represents values on the y-axis.

FIG. 8C is a graph illustrating a time series of the z-axis value of actual finger movement in the aerial-reception-range coordinate system, the z-axis value of the three-dimensional operation coordinates C, and the z-axis value of the smoothed three-dimensional operation coordinates SC. The horizontal axis of FIG. 8C represents time, and the vertical axis represents values on the z-axis.

In the graphs in FIGS. 8A to 8C, the solid lines represent the true values, or the actual coordinates of the finger, the dashed lines represent the measured values of the three-dimensional operation coordinates C, and the double lines represent the values of the smoothed three-dimensional operation coordinates SC obtained by smoothing the values of the three-dimensional operation coordinates C.

As illustrated in FIGS. 8A to 8C, the values of the three-dimensional operational coordinates C represented by dashed lines fluctuate due to the added errors compared to the true values represented by the solid lines. The values of the smoothed three-dimensional operation coordinates SC represented by the double lines contain less errors compared to the values of the three-dimensional operation coordinates C represented by the dashed lines, but the values of the smoothed three-dimensional operation coordinates SC are delayed by approximately three frames with respect to the true values represented by the solid lines.

Here, the conditions of step S10 illustrated in FIG. 7 are satisfied (yes in step S10) at t=15 during a fall in the z-axis value of the three-dimensional operation coordinates C, as indicated by the dashed line in FIG. 8C.

Then, step S11 is determined by using the x-axis value and the y-axis value of the smoothed three-dimensional operation coordinates SC at t=15.

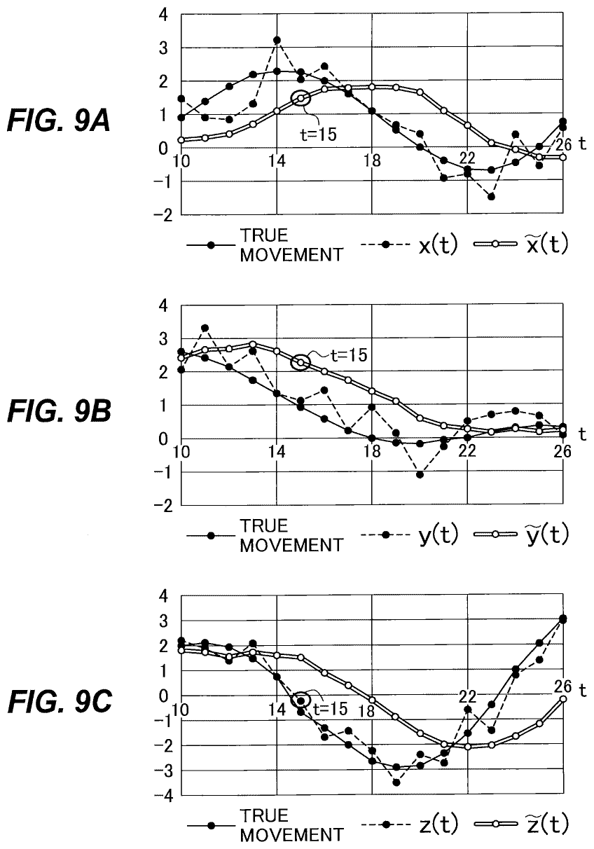

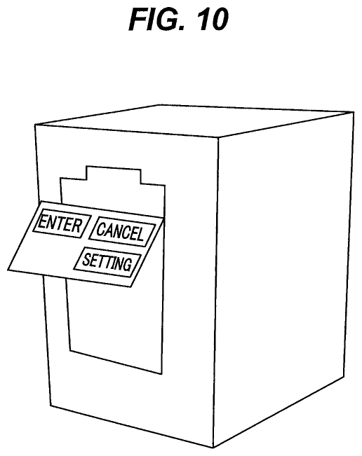

This relationship is expressed in the graphs in FIGS. 9A to 9C.

Furthermore, the values of the smoothed three-dimensional operation coordinates SC are also applied to the passage coordinates CSC indicating through which coordinates on the button 103 the finger has passed.

The passage coordinates CSC can be used for, for example, cell selection when the aerial screen corresponding to an aerial reception range R is a worksheet and many cells are provided within the worksheet. Moreover, when an aerial reception range R is a drawing area, such as a signature box for a credit card, a signature can be specified by the trajectory of the passage coordinates CSC. Furthermore, when there are several buttons 103 within a screen, as illustrated in FIG. 10, the entire screen can be covered by one aerial reception range R, so it is possible to determine which button 103 has been pressed.

It can be seen from the graph that the values are delayed by approximately three frames, but when the z-axis value of the three-dimensional operation coordinates C falls as described above, the x-axis value and the y-axis value of the three-dimensional operation coordinates C do not fluctuate much, so there is no practical problem.

In FIG. 9, while the z-axis value of the three-dimensional operation coordinates C is falling, the x-axis value and the y-axis value of the three-dimensional operation coordinates C fluctuate, but this is because these values are intentionally manipulated in order to express the delay in an easy-to-understand manner, so in any case, it is not a problem.

The aerial-reception-range passage determining unit 115 thus specifies whether a finger has passed through the aerial reception range R in a passage determination result P. The aerial-reception-range passage determining unit 115 also specifies the passage coordinates CSC indicating through which coordinates within the aerial reception range R the finger has passed.

In the first embodiment, the passage coordinates CSC are the x-axis value and y-axis value at t=15 that is the moment a fall is observed, but the first embodiment is not limited to such an example.

The passage coordinates CSC may be, for example, the weighted averages of the time point t=15 and the previous time point t=14, as expressed in expression (6) below.

$$( \frac{\tilde{x} ( 14 ) + \tilde{x} ( 15 )}{2} , \frac{\tilde{y} ( 14 ) + \tilde{y} ( 15 )}{2} ) \qquad ( 6 )$$

The passage coordinates CSC may also be values obtained by adding weighting by the z coordinate at t=15, as expressed in expression (7) below.

$$( \frac{\vert z ( 15 ) \vert \tilde{x} ( 14 ) + \vert z ( 14 ) \vert \tilde{x} ( 15 )}{2 ( z ( 14 ) + z ( 15 ) )} , \frac{\vert z ( 15 ) \vert \tilde{y} ( 14 ) + \vert z ( 14 ) \vert \tilde{y} ( 15 )}{2 ( z ( 14 ) + z ( 15 ) )} ) \qquad ( 7 )$$

Although a finger is mentioned here as an example of an instruction input object, other means such as a rod may also be used. When it is not easy to distinguish between a finger serving as an instruction input object and an object other than the finger, or when such distinction is not necessary, the three-dimensional-coordinate acquiring unit 110 and the aerial-reception-range passage determining unit 115 may determine that operation has been accepted when any object enters an aerial reception range. This means that any protrusion is permitted as an instruction input object.

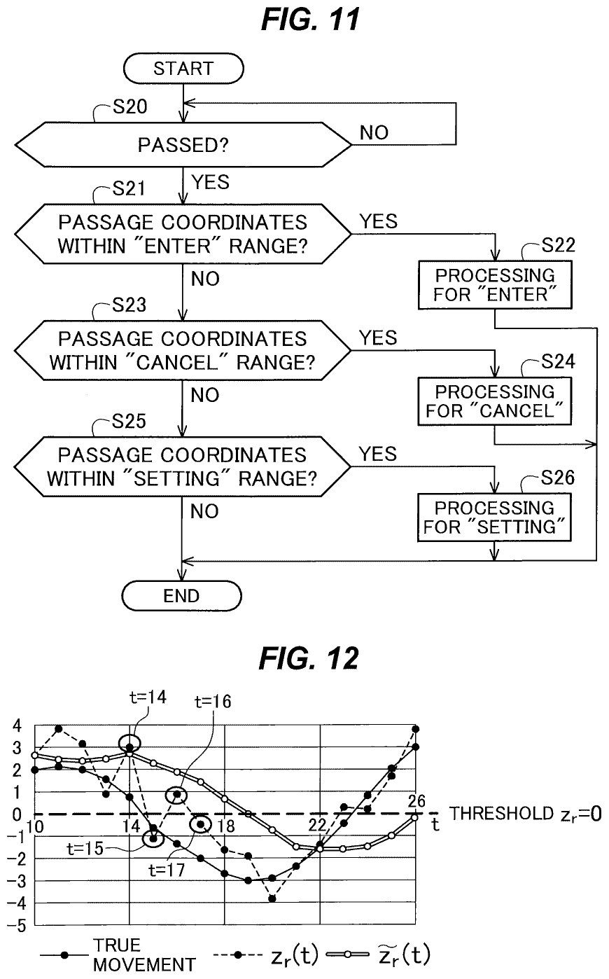

When the entire screen is covered with one aerial reception range R, it is possible to determine which process is to be performed through a flow such as that illustrated in FIG. 11.

FIG. 11 is a flowchart illustrating the operation of specifying a process in response to input to an aerial reception range R.

First, the aerial-reception-range passage determining unit 115 determines whether an instruction input object has passed through the aerial reception range R through a determination process similar to that of steps S10 and S11 in FIG. 7 (step S20). When an instruction input object passes through the aerial reception range R, the process proceeds to step S21.

In step S21, the aerial-reception-range passage determining unit 115 determines whether the passage coordinates CSC are within, for example, a range assigned to the “enter” button 103a. If the passage coordinates CSC are within the range assigned to the “enter” button 103a (Yes in step S21), the process proceeds to step S22, and if the passage coordinates CSC are not within the range assigned to the “enter” button 103a (No in step S21), the process proceeds to step S23.

In step S22, the aerial-reception-range passage determining unit 115 performs the process assigned to “enter.”

In step S23, the aerial-reception-range passage determining unit 115 determines whether the passage coordinates CSC are within, for example, a range assigned to the “cancel” button 103b. If the passage coordinates CSC are within the range assigned to the “cancel” button 103b (Yes in step S23), the process proceeds to step S24, and if the passage coordinates CSC are not within the range assigned to the “cancel” button 103b (No in step S23), the process proceeds to step S25.

In step S24, the aerial-reception-range passage determining unit 115 cancels the process.

In step S25, the aerial-reception-range passage determining unit 115 determines whether the passage coordinates CSC are within, for example, a range assigned to the “setting” button 103c. If the passage coordinates CSC are within the range assigned to the “setting” button 103c (Yes in step S25), the process proceeds to step S26, and if the passage coordinates CSC are not within the range assigned to the “setting” button 103c (No in step S25), the process ends.

In step S26, the aerial-reception-range passage determining unit 115 performs the process assigned to “setting.”

In the first embodiment described above, the time at which the button 103 is pressed, in other words, the moment when the z-axis value of the three-dimensional operation coordinates C falls is defined as the moment of operation, but the first embodiment is not limited to such an example. For example, the moment when the z-axis value of the three-dimensional operation coordinates C rises may be defined as the moment of operation.

In the first embodiment, the fingertip is detected first, and then the coordinates are transformed from a camera coordinate system to an aerial-reception-range coordinate system, but the first embodiment is not limited to such an example. For example, the coordinates of an aerial reception range R may be inversely transformed from an aerial-reception-range coordinate system to a camera coordinate system in advance. In such a case, the passing of the fingertip through the aerial reception range R and the coordinates of the point of passing can be determined in the camera coordinate system.

When multiple operations are permitted, so-called chatter occurs, where even when a user intends to perform only one operation, it is determined that multiple operations have been performed due to fluctuation caused by error in the z-axis value of the three-dimensional operation coordinates C. For example, when the z-axis value of the three-dimensional operation coordinates C transitions as illustrated in FIG. 12, the passing of a finger is erroneously determined at a time point t=17, in addition to correctly determining the passing of the finger at a time point t=15. In order to prevent such a situation, it is effective to provide different thresholds for a fall in the z-axis value of the three-dimensional operation coordinates C, i.e., transition from the positive side to the negative side, and for a rise in the z-axis value, i.e., transition from the negative side to the positive side. In specific, the threshold for detecting that an instruction input object has passed through the aerial reception range R should be set different from the threshold for detecting that the indicator input object has passed through the aerial reception range R and then returned to the side it was on before passing through the plane.

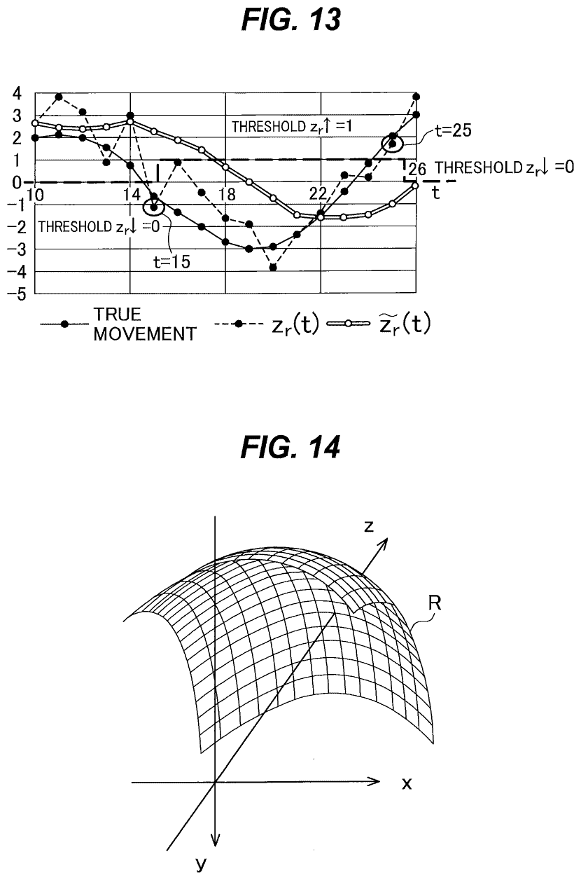

This is specifically illustrated in the graph in FIG. 13. Here, the transition of z(t), which is the z-axis value of the three-dimensional operation coordinates C, is the same as that illustrated in the graph in FIG. 12, but the threshold for a fall is set to “0,” and the threshold for a rise is set to “1.”

In this way, the threshold is “0” up to the time point t=15, and the threshold is changed to “1” after the time t=15 when a fall is observed. In this way, the chattering observed at the time point t=17 in FIG. 12 is eliminated. The threshold “1” returns to “0” at a time point t=25 when a rise is observed.

### Second Embodiment

As illustrated in FIG. 1, a contactless input device 200 according to the second embodiment also uses a mechanism mounted inside a housing 101 to project an aerial image 102 into the air, like the contactless input device 100 according to the first embodiment.

The contactless input device 200 uses an image camera 104 to detect operation to buttons 103a, 103b, and 103c included in the aerial image 102, and announces that the operation has been performed through a speaker 105.

As illustrated in FIG. 2, the contactless input device 200 according to the second embodiment includes a three-dimensional-coordinate acquiring unit 110, a smoothing processing unit 113, an aerial-image projecting unit 214, an aerial-reception-range passage determining unit 215, a feedback unit 116, and an output unit 117.

The three-dimensional-coordinate acquiring unit 110, the smoothing processing unit 113, the feedback unit 116, and the output unit 117 of the contactless input device 200 according to the second embodiment are respectively the same as the three-dimensional-coordinate acquiring unit 110, the smoothing processing unit 113, the feedback unit 116, and the output unit 117 of the contactless input device 100 according to the first embodiment.

However, in the second embodiment, the aerial-image projecting unit 214 gives an aerial reception range R to the aerial-reception-range passage determining unit 215; the aerial-reception-range passage determining unit 215 receives three-dimensional operation coordinates C from the three-dimensional-operation-coordinate detecting unit 112, receives smoothed three-dimensional operation coordinates SC from the smoothing processing unit 113, gives a passage determination result P to the feedback unit 116, and outputs the passage coordinates CSC to the output unit 117.

The aerial-image projecting unit 214 projects a curved plane that is a portion of a spherical plane, as illustrated in FIG. 14, into the air. The aerial reception range R in the second embodiment is assumed to coincide with the curved plane. The aerial reception range R in FIG. 14 is illustrated with a mesh to make it easier to visually capture the shape.

The aerial reception range R shaped like a curved plane that is a portion of a spherical plane is superior to a flat plane as a user interface. For example, it is generally thought that a user operates the contactless input device 200 near the center of the aerial reception range R, but when the aerial reception range R is a flat plane as in the first embodiment, the distances from the user to the aerial reception range differs greatly between the center and an edge of the aerial reception range R. In contrast, when the aerial reception range R is a curved plane, this difference in distance can be eliminated or reduced. However, the aerial reception range R illustrated in FIG. 14 is exaggerated to emphasize the differences from that of the first embodiment, and in practical terms, a flatter aerial reception range R with a slightly higher curvature is useful.

The aerial-reception-range passage determining unit 215 expresses the aerial reception range R with a function f(x,y,z)=0 representing a plane containing the aerial reception range R, and restricts the aerial reception range R by functions gₓ(x,y,z) and g_{y}(x,y,z), which represent coordinates within the aerial reception range.

Since the aerial reception range R in the second embodiment is a portion of a spherical plane, f(x,y,z) is a function representing a spherical plane. In specific, f(x,y,z)=(x−xᵣ)²+(y−yᵣ)²+(z−zᵣ)²−d², where the center of the spherical plane is (xᵣ, yᵣ, zᵣ) and the radius of the spherical plane is d.

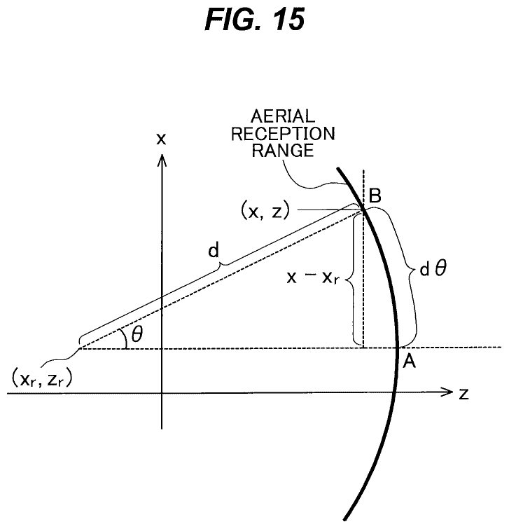

The length of an arc AB illustrated in FIG. 15 is expressed by gₓ(x,y,z). FIG. 15 is a cross-sectional diagram of the aerial reception range R and its the vicinity taken along a plane perpendicular to the y-axis.

Here, the length of the arc AB is de from the arc length formula. Since the hypotenuse side is d, and the opposite side is x−xᵣ, θ is expressed by the following expression (8).

$$θ = {sin}^{- 1} ( \frac{x - {x}_{r}}{d} ) \qquad ( 8 )$$

In other words, the following expression (9) is established.

$${g}_{x} ( x , y , z ) = d {sin}^{- 1} ( \frac{x - {x}_{r}}{d} ) \qquad ( 9 )$$

Similarly, the following expression (10) is established for g_{y}.

$${g}_{y} ( x , y , z ) = d {sin}^{- 1} ( \frac{y - {y}_{r}}{d} ) \qquad ( 10 )$$

Here, it is assumed that the coordinates (x, y, z) are in the aerial reception range R. Therefore, more exactly, the following expressions (11) and (12) are established for gₓ and g_{y} by replacing (x, y, z) at the intersection of f(x) and the line connecting (x, y, z) and the center of the sphere.

$$( 11 )$$

$${g}_{y} ( x , y , z ) = d {sin}^{- 1} [ \{ \frac{xd + {x}_{r} ( \sqrt{{( x - {x}_{r} )}^{2} + {( y - {y}_{r} )}^{2} {( z - {z}_{r} )}^{2}} - d )}{\sqrt{{( x - {x}_{r} )}^{2} + {( y - {y}_{r} )}^{2} + {( z - {z}_{r} )}^{2}}} - {x}_{r} \} / d ]$$

$$( 12 )$$

$${g}_{y} ( x , y , z ) = d {sin}^{- 1} [ \{ \frac{yd + {y}_{r} ( \sqrt{{( x - {x}_{r} )}^{2} + {( y - {y}_{r} )}^{2} {( z - {z}_{r} )}^{2}} - d )}{\sqrt{{( x - {x}_{r} )}^{2} + {( y - {y}_{r} )}^{2} + {( z - {z}_{r} )}^{2}}} - {y}_{r} \} / d ]$$

However, as described later, gₓ and g_{y} are realistically used at the moment when an instruction input object crosses f(x,y,z), and since the coordinates (x, y, z) are sufficiently close to the spherical plane, there is no significant difference even if expressions (9) and (10) are used in place of expressions (11) and (12), respectively.

As described above, by determining coordinates within the aerial reception range R, and setting a restriction on the coordinate area as |gₓ(x,y,z)|<xₘₐₓ, g_{y}(x,y,z)|<yₘₐₓ, and z>0, it is possible to express the aerial reception range R, which is a portion of a spherical plane such as that illustrated in FIG. 14.

Expressions (9) and (10) can be further simplified to gₓ(x,y,z)=x−xᵣ and g_{y}(x,y,z)=y−yᵣ since the inverse sine function can be approximated to sin⁻¹x=x in the range where the angle is small.

On the basis of these expressions, the aerial-reception-range passage determining unit 215 according to the second embodiment determines whether a finger, which is an example of an instruction input object, has passed through an aerial reception range R from three-dimensional operation coordinates C and the aerial reception range R indicated by aerial reception range information from the aerial-image projecting unit 114. The aerial-reception-range passage determining unit 215 then gives a passage determination result P indicating the determination result to the feedback unit 116.

Here, the aerial-reception-range passage determining unit 215 establishes a function f(x,y,z) where points in the aerial reception range R satisfy f(x,y,z)=0. In this way, when f(x,y,z) transitions from positive to negative or vice versa, it always passes through the aerial reception range R established as f(x,y,z)=0. Thus, the aerial-reception-range passage determining unit 215 can determine whether an instruction input object has passed through an aerial reception range by confirming the value of f(x,y,z).

In the second embodiment, the aerial reception range R is a portion of a spherical plane, as illustrated in FIG. 14.

The aerial-reception-range passage determining unit 215 also specifies passage coordinates, which are coordinates at which the instruction input object has passed through the aerial reception range R by using smoothed three-dimensional operation coordinates SC.

In specific, the aerial-reception-range passage determining unit 215 specifies passage coordinates CSC indicating through which coordinates a finger, or an instruction input object, has passed through the aerial reception range R on the basis of the smoothed three-dimensional operation coordinates SC from the smoothing processing unit 113.

Here, the passage coordinates CSC are composed of an x-axis value, a y-axis value, and a z-axis value of the smoothed three-dimensional operation coordinates SC at a time point t determined to be the time point at which a finger, which is an example of an instruction input object, has passed through the aerial reception range R on the basis of the three-dimensional operation coordinates C.

Furthermore, when the specified passage coordinates CSC are within the aerial reception range R, the aerial-reception-range passage determining unit 215 determines that the instruction input object has passed through the aerial reception range R, in other words, input has been made to the aerial reception range R.

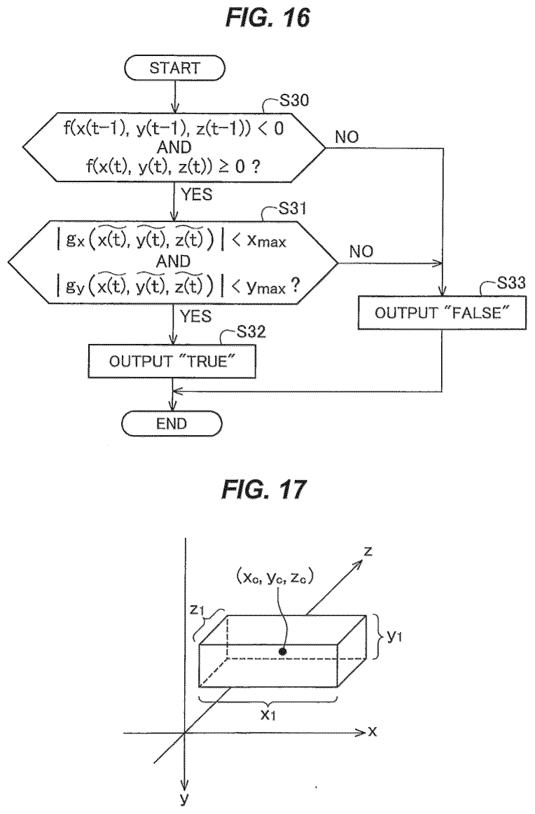

FIG. 16 is a flowchart illustrating the operation of determining whether an instruction input object has passed through an aerial reception range R in the second embodiment.

First, the aerial-reception-range passage determining unit 215 determines whether f(x(t−1), y(t−1), z(t−1)), which is a value of the function f at a time point t−1, is negative, and whether f(x(t), y(t), z(t)), which is a value of the function f at a time point t, is positive or zero (step S30).

This corresponds to the so-called rise of f(x(t), y(t), z(t)). This method enables determination because a point (x₁, y₁, z₁) where f(x₁, y₁, z₁)<0 and a point (x₂, y₂, z₂) where f(x₂, y₂, z₂)>0 exist at positions on opposite sides of the plane f(x,y,z)=0. Similar to the first embodiment, it is important that pre-smoothing values, i.e., three-dimensional operation coordinates C, are used for the determination.

Next, the aerial-reception-range passage determining unit 215 determines whether the passage coordinates CSC, which are smoothed x, y, and z coordinate values of the smoothed three-dimensional operation coordinates SC at the time point t, satisfy expressions (13) and (14) below (step S31).

$$\vert {g}_{x} ( , , ) \vert < {x}_{max} \qquad ( 13 )$$

$$\vert {g}_{y} ( , , ) \vert < {y}_{max} \qquad ( 14 )$$

If both expressions (13) and (14) are satisfied (Yes in step S31), the process proceeds to step S32, and if at least one of expressions (13) and (14) is not satisfied (No in step S31), the process proceeds to step S33.

In step S32, the aerial-reception-range passage determining unit 315 determines that the instruction input object has passed through a target aerial reception range R. Here, the x- and y-coordinates of the passage coordinates are as expressed by expression (15) below.

$$( {g}_{x} ( , , ) , {g}_{y} ( , , ) ) \qquad ( 15 )$$

Meanwhile, in step S33, the aerial-reception-range passage determining unit 315 determines that the instruction input object has not passed through a target aerial reception range R.

When multiple aerial reception ranges R are provided, the aerial-reception-range passage determining unit 315 can specify through which aerial reception range R the instruction input object has passed by executing the above flowchart for every aerial reception range R.

In the second embodiment described above, the aerial reception range R is a portion of a spherical plane; however, the second embodiment can also be implemented in the same way by using a function f(x,y,z) indicating an aerial reception range R that has any shape with mediating variables of an aerial-reception-range coordinate system (x, y, z).

For example, as illustrated in FIG. 17, when an aerial reception range R has a cuboid shape where the center is (x_{c}, y_{c}, z_{c}) and the lengths along the x, y, and z axes are x₁, y₁, and z₁, respectively, the function f may be expressed by the following expression (16).

$$f ( x , y , z ) = max ( \vert x - {x}_{c} \vert - \frac{{x}_{l}}{2} , \vert y - {y}_{c} \vert - \frac{{y}_{l}}{2} , \vert z - {z}_{c} \vert - \frac{{z}_{l}}{2} ) \qquad ( 16 )$$

Although the illustration is omitted, when an aerial reception range R has a parabolic shape, the function f can be expressed by expression (17) below.

$$f ( x , y , z ) = \frac{{( x - {x}_{r} )}^{2}}{{a}^{2}} + \frac{{( y - {y}_{r} )}^{2}}{{b}^{2}} - ( z - {z}_{r} ) \qquad ( 17 )$$

Here, xᵣ and yᵣ are fixed points, and zᵣ is a bottom plane containing a fixed line of a corresponding parabola.

In this way, f(x,y,z) may be a polynomial of a hyperbolic surface or the like, a shape expressed by a triangular polynomial or the like, and since differentiability does not matter, f(x,y,z) may also be a table containing mediating variables that are x, y, and z or polynomials combining x, y, and z, or a combination of two or more planes, which is a so-called polygon. The cuboid described above is an example of a polygon.

The first embodiment is a specific case of the second embodiment. That is, the first embodiment is the same as the second embodiment, except that the function f(x,y,z) represents a shape with no x-terms and y-terms but only a first-order term of z, as in f(x,y,z)=−z, and the function gₓ represents a shape with no y-terms and z-terms but only a first-order term of x, and the function g_{y} represents a shape with no z-terms and x-terms but only a first-order term of y, such as in gₓ(x,y,z)=x+C₂ and g_{y}(x,y,z)=y+C₃, where C₂ and C₃ are constants.

### Third Embodiment

As illustrated in FIG. 1, a contactless input device 300 according to the third embodiment also uses a mechanism mounted inside a housing 101 to project an aerial image 102 into the air, like the contactless input device 100 according to the first embodiment.

The contactless input device 300 uses an image camera 104 to detect operation to buttons 103a, 103b, and 103c included in the aerial image 102, and announces that the operation has been performed through a speaker 105.

As illustrated in FIG. 2, the contactless input device 300 according to the third embodiment includes a three-dimensional-coordinate acquiring a unit 110, smoothing processing unit 113, an aerial-image projecting unit 114, an aerial-reception-range passage determining unit 315, a feedback unit 116, and an output unit 117.

The three-dimensional-coordinate acquiring unit 110, the smoothing processing unit 113, the aerial-image projecting unit 114, the feedback unit 116, and the output unit 117 of the contactless input device 300 according to the third embodiment are respectively the same as the three-dimensional-coordinate acquiring unit 110, the smoothing processing unit 113, the aerial-image projecting unit 114, the feedback unit 116, and the output unit 117 of the contactless input device 100 according to the first embodiment.

The aerial-reception-range passage determining unit 315 according to the third embodiment receives three-dimensional operation coordinates C from the three-dimensional-operation-coordinate detecting unit 112, an aerial reception range R from the aerial-image projecting unit 114, and smoothed three-dimensional operation coordinates SC from the smoothing processing unit 113, gives a passage determination result P to the feedback unit 116, and specifies passage coordinates CSC.

Similar to the first embodiment, the aerial-reception-range passage determining unit 315 determines whether a finger, which is an example of an instruction input object, has passed through an aerial reception range R from three-dimensional operation coordinates C and the aerial reception range R indicated by aerial reception range information from the aerial-image projecting unit 114. The aerial-reception-range passage determining unit 315 then gives a passage determination result P indicating the determination result to the feedback unit 116.

The aerial-reception-range passage determining unit 315 according to the third embodiment specifies passage coordinates CSC indicating through which coordinates a finger, or an instruction input object, has passed through the aerial reception range R on the basis of the smoothed three-dimensional operation coordinates SC from the smoothing processing unit 113. Here, the passage coordinates CSC at a time point t are specified to be the x-axis value and the y-axis value obtained from the above expression (3) for a time point t+D, which is a time point later than a time point t by a predetermined delay time D, where the time point t is when a finger, which is an example of an instruction input object, is determined to have passed through the aerial reception range R on the basis of the three-dimensional operation coordinates C and the aerial reception range R indicated by aerial reception range information from the aerial-image projecting unit 114.

Furthermore, when multiple aerial reception ranges R are established, the aerial-reception-range passage determining unit 315 determines which aerial reception range R of the multiple aerial reception ranges R the instruction input object has passed on the basis of the specified passage coordinates CSC and the aerial reception ranges R indicated by the aerial reception range information from the aerial-image projecting unit 114.

In other words, in the third embodiment, the aerial-reception-range passage determining unit 315 specifies a value of a first axis extending in a direction intersecting the aerial reception range R out of the three axes from the three-dimensional operation coordinates C, and uses the specified value to specify the time point at which the instruction input object has passed through the aerial reception range R. The aerial-reception-range passage determining unit 215 specifies values of second and third axes other than the first axis among the three axes at a delay time point, which is a time point later than the specified time point, as passage coordinates CSC from the smoothed three-dimensional operation coordinates SC. When the passage coordinates CSC are within the aerial reception range R, the aerial-reception-range passage determining unit 215 determines that input has been made to the aerial reception range R.

Here, the delay time point may be determined by adding time equal or less than the delay time, which is the time for the smoothing processing unit 113 to calculate the smoothed three-dimensional operation coordinates, to the specified time point.

For example, when the smoothing processing unit 113 performs smoothing by using a linear phase filter, the delay time may be a group delay value of the linear phase filter.

In the third embodiment, also, the feedback unit 116 provides output at the time point when the passage determination result P becomes true, as in the first embodiment. In this way, a user can receive a response to the operation quickly.

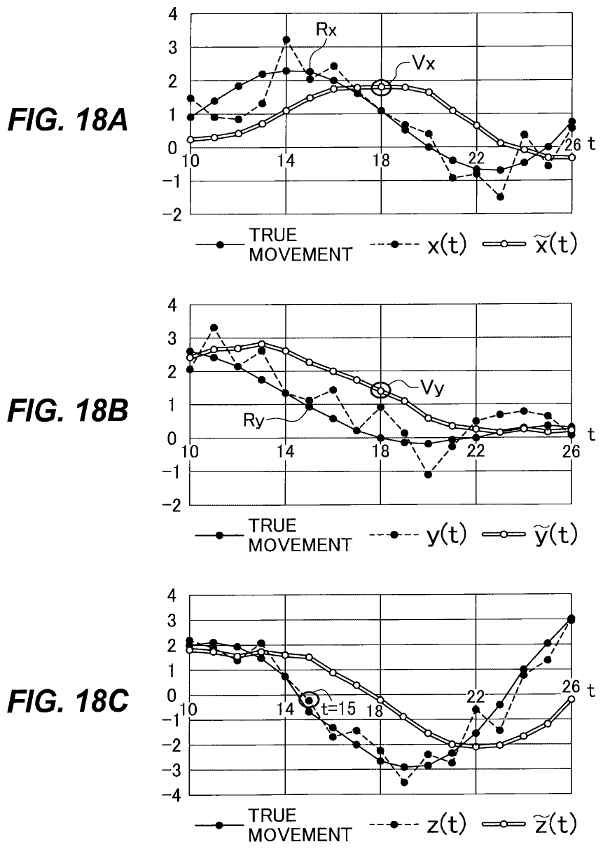

The operation of the aerial-reception-range passage determining unit 315 according to the third embodiment will now be explained with reference to FIG. 18.

FIGS. 18A to 18C are graphs for explaining in detail the operation of the aerial-reception-range passage determining unit 315.

The graphs in FIGS. 18A to 18C are the same as those in FIGS. 8A to 8C, respectively.

Here, the delay time D is “3,” which corresponds to the time of three frames.

As illustrated in FIG. 18C, the passage determination result P become true at a time point t=15 because the z-axis value z(t) of the three-dimensional operation coordinates C falls. However, since the delay time D is “3,” the aerial-reception-range passage determining unit 315 does not specify the passage coordinates CSC at this moment.

Then, at a time point t=18, which is a time point determined by adding the delay time D=3 to the time point t=15, the aerial-reception-range passage determining unit 315 specifies an x-axis value Vx and a y-axis value Vy of the smoothed three-dimensional operation coordinates SC at the time point t=18 as the passage coordinates CSC at the time point t=15.

The delay time D is set to “3” from the viewpoint of canceling group delay of a seven-tap moving average filter. Thus, as illustrated in FIGS. 18A and 18C, the values (Vx, Vy) of the passage coordinates CSC at the time point t=15 approximates the true values (Rx, Ry) at the time point t=15.

Therefore, the third embodiment is effective when one wishes to use values closer to the true values as the values of the passage coordinates CSC. Meanwhile, feedback to the user is given at the moment of reception, that is, at the time point t=15, so the user perceives the responsiveness as being satisfactory. However, since the passage coordinates CSC are specified at a time point that takes the delay time D into account, the actual processing time is not shortened when processing using the passage coordinates CSC is required.

At this time, if the duration of feedback to the user is set to the delay time D or longer, the user is less likely to perceive the feedback as being wrong, so it is more desirable. This is because before feedback to the user is completed, the passage coordinates CSC are specified, and substantial processing can be started.

Here, a moving average filter is used as a smoothing filter, but for example, when a smoothing method having nonlinear phase characteristics, such as an IIR filter, is used, the delay time differs for each frequency component, so it is difficult to determine the delay time D.

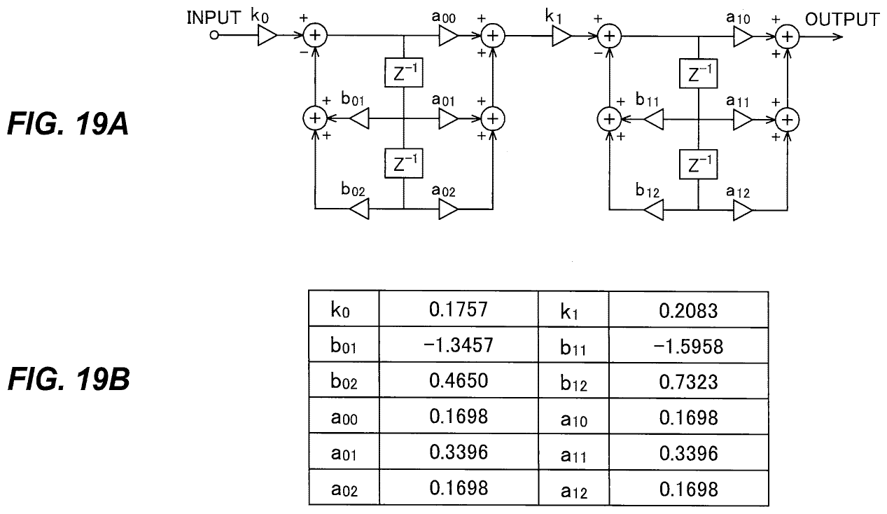

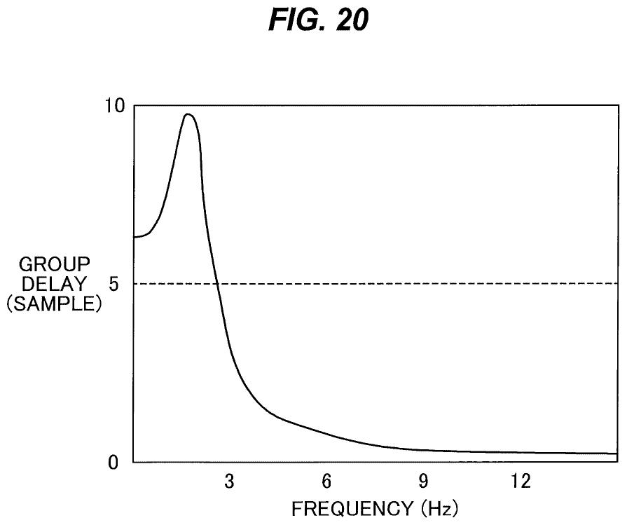

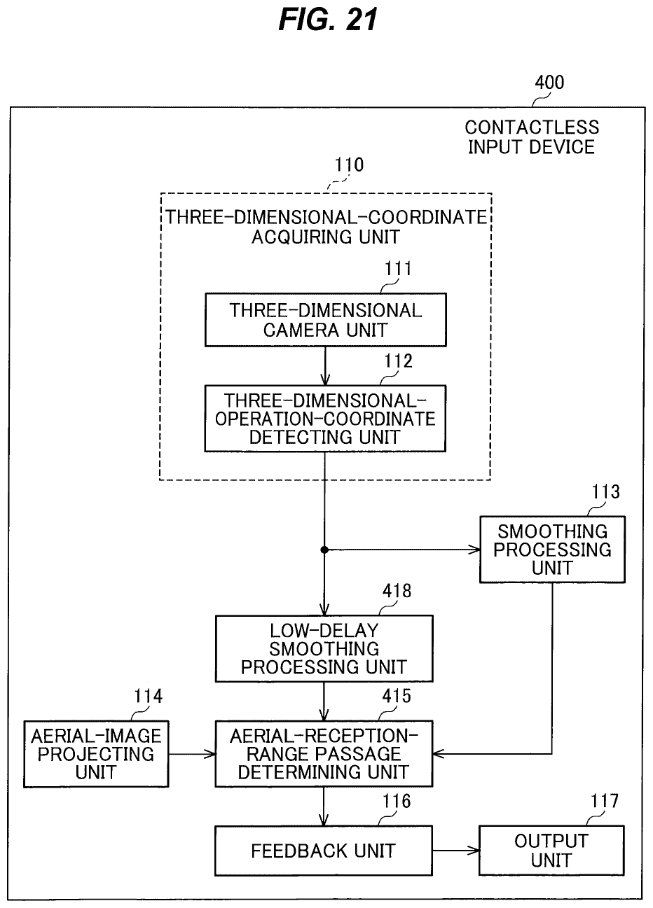

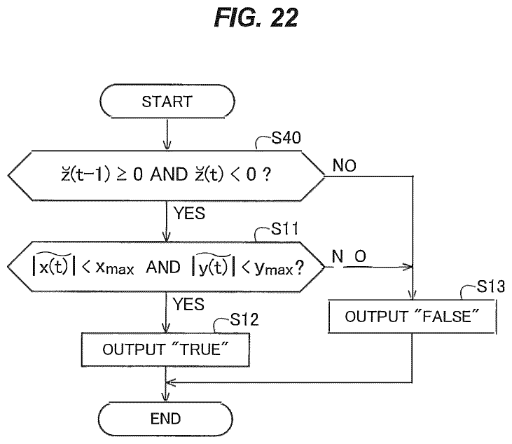

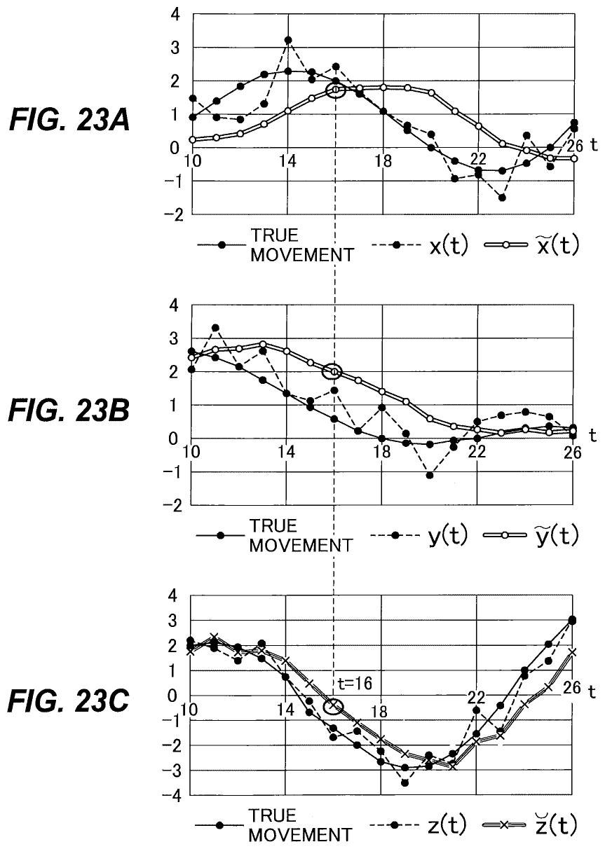

For example, FIGS. 19A and 19B are schematic diagrams illustrating a configuration of a two-stage cascade type IIR filter.

FIG. 20 is a graph illustrating the group delay characteristics of the two-stage cascade IIR filter illustrated in FIGS. 19A and 19B.

Here, FIG. 20 illustrates a case where the frame rate of the image camera 104 is 30 frames per second.

Although the group delay fluctuates depending on the frequency, as illustrated, the maximum group delay is 10 samples or less. It is reasonable to set the delay time D within the range of the minimum value to the maximum value of the group delay characteristics, which in this case is within the range of zero to 10 samples. For example, one way of thinking is to set the delay time D to a time corresponding to seven samples from the group delay of DC components.

Here, the frequency is 30 Hz because it is derived from the sampling rate of the three-dimensional operation coordinates C.

However, since a reduction in the delay time D leads to a reduction in essential processing time when processing using the passage coordinates CSC is required, there is also an advantage in setting the delay time D to a value smaller than “7.”

Furthermore, based on this knowledge, there is an advantage in setting the delay time D to a value smaller than a flat group delay even when a filter having linear phase characteristics, such as a moving average filter or an FIR filter designed by the window function method, is used. For example, in the case of a seven-tap moving average filter, there is also an advantage in setting the delay time D to “2” or “1,” which is smaller than three samples, or the group delay. This is effective when it is necessary to balance both the substantial processing time and the accuracy of the passage coordinates CSC.

When the delay time D is “0,” the operation in the third embodiment is consistent with that in the first embodiment.

### Fourth Embodiment

As illustrated in FIG. 1, a contactless input device 400 according to the fourth embodiment also uses a mechanism mounted inside a housing 101 to project an aerial image 102 into the air, like the contactless input device 100 according to the first embodiment.

The contactless input device 400 uses an image camera 104 to detect operation to buttons 103a, 103b, and 103c included in the aerial image 102, and announces that the operation has been performed through a speaker 105.

FIG. 21 is a block diagram schematically illustrating a configuration of the contactless input device 400 according to the fourth embodiment.

The contactless input device 400 according to the fourth embodiment includes a three-dimensional-coordinate acquiring unit 110, a smoothing processing unit 113, an aerial-image projecting unit 114, an aerial-reception-range passage determining unit 415, a feedback unit 116, an output unit 117, and a low-delay smoothing processing unit 418.

The three-dimensional-coordinate acquiring unit 110, the smoothing processing unit 113, the aerial-image projecting unit 114, the feedback unit 116, and the output unit 117 of the contactless input device 400 according to the fourth embodiment are respectively the same as the three-dimensional-coordinate acquiring unit 110, the smoothing processing unit 113, the aerial-image projecting unit 114, the feedback unit 116, and the output unit 117 of the contactless input device 100 according to the first embodiment.

The low-delay smoothing processing unit 418 receives three-dimensional operation coordinates C from the three-dimensional-operation-coordinate detecting unit 112, smooths the three-dimensional operation coordinates C in the time direction through smoothing processing with delay lower than that by the smoothing processing unit 113, and gives the result to the aerial-reception-range passage determining unit as 415 low-delay smoothed three-dimensional operation coordinates LSC.

In other words, the low-delay smoothing processing unit 418 calculates the low-delay smoothed three-dimensional operation coordinates LSC by performing smoothing using a predetermined second number of sets (second number ≥2) of three-dimensional operation coordinates C out of multiple sets of three-dimensional operation coordinates C with a delay time shorter than the time for the smoothing processing unit 113 to calculate the smoothed three-dimensional operation coordinates SC.

When the smoothing processing unit 113 applies smoothing with a seven-tap moving average filter, as described above, the low-delay smoothing processing unit 418, for example, calculates the low-delay smoothed three-dimensional operation coordinates LSC by applying smoothing with a three-tap moving average filter as expressed by expression (18) below.

$$( \begin{matrix}{x}^{⌣} ( t ) \\ {y}^{⌣} ( t ) \\ {z}^{⌣} ( t )\end{matrix} ) = ( \begin{matrix}\frac{1}{3} {\sum }_{k = 0}^{2} x ( t - k ) \\ \frac{1}{3} {\sum }_{k = 0}^{2} y ( t - k ) \\ \frac{1}{3} {\sum }_{k = 0}^{2} z ( t - k )\end{matrix} ) \qquad ( 18 )$$

The aerial-reception-range passage determining unit 415 according to the fourth embodiment receives the low-delay smoothed three-dimensional operation coordinates LSC from the low-delay smoothing processing unit 418, an aerial reception range R from the aerial-image projecting smoothed unit 114, and three-dimensional operation coordinates SC from the smoothing processing unit 113, gives a passage determination result P to the feedback unit 116, and specifies passage coordinates CSC.

The aerial-reception-range passage determining unit 415 determines whether a finger, which is an example of an instruction input object, has passed through an aerial reception range R on the basis of the low-delay smoothed three-dimensional operation coordinates LSC and the aerial reception range R indicated by the aerial reception range information from the aerial-image projecting unit 114. The aerial-reception-range passage determining unit 415 then gives a passage determination result P indicating the determination result to the feedback unit 116.

For example, as in the first embodiment, he aerial-reception-range passage determining unit 415 according to the fourth embodiment specifies passage coordinates CSC indicating through which coordinates a finger, or an instruction input object, has passed through the aerial reception range R on the basis of the smoothed three-dimensional operation coordinates SC from the smoothing processing unit 113. Here, the passage coordinates CSC are composed of the x-axis value and the y-axis value obtained from the above expression (3) at a time point t, which is the time point when a finger, which is an example of an instruction input object, is determined to have passed through the aerial reception range R on the basis of three-dimensional operation coordinates C and the aerial reception range R indicated by the aerial reception range information from the aerial-image projecting unit 114.

Furthermore, as in the first embodiment, when multiple aerial reception ranges R are established, the aerial-reception-range passage determining unit 415 determines which aerial reception range R of the multiple aerial reception ranges R the instruction input object has passed on the basis of the specified passage coordinates CSC and the aerial reception ranges R indicated by the aerial reception range information from the aerial-image projecting unit 114.

In other words, in the fourth embodiment, the aerial-reception-range passage determining unit 415 specifies a value of a first axis extending in a direction intersecting the aerial reception range R out of the three axes from the low-delay smoothed three-dimensional operation coordinates LSC, and uses the specified value to specify the time point at which the instruction input object has passed through the aerial reception range R. The aerial-reception-range passage determining unit 415 specifies the values of the second and third axes, which are two of the three axes (excluding the first axis), of the specified time point as passage coordinates CSC on the basis of the smoothed three-dimensional operation coordinates SC. When the passage coordinates CSC are within the aerial reception range R, the aerial-reception-range passage determining unit 415 determines that input has been made to the aerial reception range R.

Here, the low-delay smoothing processing unit 418 can also perform smoothing through a method other than the three-tap moving average filter. For example, it is conceivable to use an FIR filter, an IIR filters, or the like based on a window function method or the like.

Some or all of the three-dimensional-operation-coordinate detecting unit 112, the smoothing processing unit 113, the aerial-reception-range passage determining unit 415, the feedback unit 116, and the low-delay smoothing processing unit 418 described above can be implemented by, for example, a memory 10 and a processor 11 such as a CPU that executes a program stored in the memory 10, as illustrated in FIG. 6A. Such programs may be provided over a network or may be recorded and provided on a recording medium. That is, such programs may be provided, for example, as a program product.

Some or all of the three-dimensional-operation-coordinate detecting unit 112, the smoothing processing unit 113, the aerial-reception-range passage determining unit 415, the feedback unit 116, and the low-delay smoothing processing unit 418 can also be implemented by, for example, the processing circuit 12, as illustrated in FIG. 6B.

As described above, the three-dimensional-operation-coordinate detecting unit 112, the smoothing processing unit 113, the aerial-reception-range passage determining unit 415, the feedback unit 116, and the low-delay smoothing processing unit 418 can be implemented by processing circuitry.

The operation of the aerial-reception-range passage determining unit 415 according to the fourth embodiment will now be explained.

FIG. 22 is a flowchart illustrating the operation of determining whether an instruction input object has passed through an aerial reception range R in the fourth embodiment.

Here, the aerial reception range R is assumed to be (|x|<xₘₐₓ, |y|<yₘₐₓ, Z=0), as illustrated in FIG. 5.

In the flowchart illustrated in FIG. 22, steps of the same process as that in the flowchart of in FIG. 7 are denoted by the same reference signs as in FIG. 7.

First, the aerial-reception-range passage determining unit 415 determines whether the z coordinate value of the low-delay smoothed three-dimensional operation coordinates LSC at a time point t−1, is positive or zero, and whether the z coordinate value of the low-delay smoothed three-dimensional operation coordinates LSC at a time point t, is negative (step S40). If the condition of step S40 is satisfied (Yes in step S40), the process proceeds to step S11, and if the condition of step S40 is not satisfied (No in step S40), the process proceeds to step S13.

The process of steps S11 to S13 in FIG. 22 is the same as the process of steps S11 to S13 in FIG. 7.

In the first embodiment, a fall is determined by using the z-axis value of the three-dimensional operation coordinates C without smoothing, but in the fourth embodiment, a fall is determined by using the z-axis value of the low-delay smoothed three-dimensional operation coordinates LSC, which does not have a very long delay time.

FIGS. 23A to 23C illustrate the above operation in detail.

FIGS. 23A to 23C are graphs for explaining the operation of the aerial-reception-range passage determining unit 415.

FIG. 23A is a graph illustrating a time series of the x-axis value of actual finger movement in an aerial-reception-range coordinate system, the x-axis value of three-dimensional operation coordinates C, and the x-axis value of smoothed three-dimensional operation coordinates SC. The horizontal axis of FIG. 23A represents time, and the vertical axis represents x-axis values.

FIG. 23B is a graph illustrating a time series of the y-axis value of actual finger movement in an aerial-reception-range coordinate system, the y-axis value of the three-dimensional operation coordinates C, and the y-axis value of the smoothed three-dimensional operation coordinates SC. The horizontal axis of FIG. 23B represents time, and the vertical axis represents values on the y-axis.

FIG. 23C is a graph illustrating a time series of the z-axis value of actual finger movement in the aerial-reception-range coordinate system, the z-axis value of the three-dimensional operation coordinates C, and the z-axis value of the low-delay smoothed three-dimensional operation coordinates LSC. The horizontal axis of FIG. 23C represents time, and the vertical axis represents values on the z-axis.

In the graphs in FIGS. 23A to 23C, the solid lines represent the true values, or the actual coordinates of the finger, and the dashed lines represent the measured values of the three-dimensional operation coordinates C.

In FIGS. 23A and 23B, the double lines represent the values of the 41 smoothed three-dimensional operation coordinates SC obtained by smoothing the values of the three-dimensional operation coordinates C In FIG. 23C, the double line represents the values of the low-delay smoothed three-dimensional operation coordinates LSC obtained by smoothing the values of the three-dimensional operation coordinates C with low delay.

As illustrated in FIG. 23C, the time point at which the z-axis value of the low-delay smoothed three-dimensional operation coordinates LSC falls from the positive side to the negative side is t=16, and this is a one-frame delay with respect to the z-axis value of the three-dimensional operation coordinates C and is small compared to the three-frame delay of the z-axis value of the smoothed three-dimensional operation coordinates SC with respect to the z-axis value of the three-dimensional operation coordinates C. Therefore, also in the third embodiment, a passage determination result P can be outputted relatively quickly, and thus feedback to the user can also be outputted relatively quickly.

Furthermore, since the x-axis values and the y-axis values of the smoothed three-dimensional operation coordinates SC can be used as passage coordinates within the aerial reception range, values subjected to more intense smoothing can be used. Since there is a relatively high delay in the smoothed three-dimensional operation coordinates SC, there is a problem of outputting the coordinates of an instruction input object for a past time point. However, as in the first embodiment, when a user of the contactless input device 400 operates a button 103 in the air, there is a realistic tendency for the user to move their finger in a direction perpendicular to the button 103. Therefore, when a finger is moved in this direction, the x-axis value and the y-axis value of the smoothed three-dimensional operation coordinates SC are substantially constant, so it is thought that the length of this delay is unlikely to become a problem.

As described above, according to the first to fourth embodiments, since the smoothed three-dimensional operation coordinates SC are used to detect coordinates through an instruction input object passes, which fluctuation due to time-varying noise during detection by the operation input means can be removed.

However, when an instruction input object is detected in the air, the sampling rate is generally low, and the delay in the smoothing algorithm is relatively high. As a specific example, when a three-dimensional camera with a frame rate of 30 frames per second is used to detect the position of an instruction input object, and a seven-tap moving average filter is used for smoothing, the delay is 100 ms. As a result, the response speed of the system decreases, and the user's sense of operation deteriorates.

Therefore, in the first to fourth embodiments, it is possible to achieve both system responsiveness and detection position accuracy by using values that have not been smoothed or values that have been smoothed with low delay when determining whether an instruction input object has passed through a plane including a range that accepts operation.

In the first to fourth embodiments described above, each of the aerial-reception-range passage determining units 115 to 415 give a passage determination result P to the feedback unit 116 on the basis of the z-axis value of the three-dimensional operation coordinates C or the low-delay smoothed three-dimensional operation coordinates LSC, but the first to fourth embodiments are not limited to such examples. For example, each of the aerial-reception-range passage determining units 115 to 415 may give a passage determination result P to the feedback unit 116 when the passage coordinates CSC are within the corresponding range. Moreover, each of the aerial-reception-range passage determining units 115 to 415 may give a passage determination result P to the feedback unit 116 when the x-axis value and the y-axis value of the three-dimensional operation coordinates C or the low-delay smoothed three-dimensional operation coordinates LSC are within a corresponding range at the time of a fall in the z-axis value of the three-dimensional operation coordinates C or the low-delay smoothed three-dimensional operation coordinates LSC.

In each of the third and fourth embodiments described above, the aerial reception range R is a flat plane to simplify the explanation; however, as in the second embodiment, the aerial reception range R may be a portion of a shape expressed by a polynomial, a triangular polynomial, or the like, such as a spherical or parabolic plane, may be shaped like a table containing mediating variables that are x, y, z, or polynomial values combining them because differentiability is unquestionable, or may be a combination of two or more planes (for example, a cuboid or a polyhedron), which is a so-called polygon.

For example, in the fourth embodiment, the aerial-reception-range passage determining unit 415 determines whether the instruction input object has passed through the aerial reception by range a R using function predetermined such that the output of the function that takes the low-delay smoothed three-dimensional operation coordinates LSC as input is a predetermined value in the aerial reception range R. Here, the aerial-reception-range passage determining unit 415 sequentially inputs multiple sets of low-delay smoothed three-dimensional operation coordinates LSC to the function, and when an output of the function becomes larger or smaller than the predetermined value, the aerial-reception-range passage determining unit 415 determines whether the instruction input object has passed through the aerial reception range R.

### DESCRIPTION OF REFERENCE CHARACTERS

100, 200, 300, 400 contactless input device; 101 housing; 102 aerial image; 103 button; 104 image camera; 105 speaker; 110 three-dimensional-coordinate acquiring unit; 111 three-dimensional camera unit; 112 three-dimensional-operation-coordinate detecting unit; 113 smoothing processing unit; 114 aerial-image projecting unit; 115, 215, 315, 415 aerial-reception-range passage determining unit; 116 feedback unit; 117 output unit; 418 low-delay smoothing processing unit.

1.-21. (canceled)

22. A contactless input device comprising:
processing circuitry
to detect multiple sets of three-dimensional operation coordinates by sequentially detecting the three-dimensional operation coordinates, the three-dimensional operation coordinates being triaxial coordinates of an instruction input object in a predetermined space, the instruction input object being an object for inputting an instruction;
to calculate smoothed three-dimensional operation coordinates by performing smoothing by using a predetermined first number of sets of three-dimensional operation coordinates included in the multiple sets of three-dimensional operation coordinates, the first number being two or more;
to calculate low-delay smoothed three-dimensional operation coordinates by performing smoothing by using a predetermined second number of sets of three-dimensional operation coordinates included in the multiple sets of three-dimensional operation coordinates with a delay time shorter than a time for the smoothing processing unit to calculate the smoothed three-dimensional operation coordinates, the second number being two or more; and
to use the low-delay smoothed three-dimensional operation coordinates to determine whether the instruction input object has passed through an aerial reception range, and to specify passage coordinates by using the smoothed three-dimensional operation coordinates, the passage coordinates being coordinates at which the instruction input object passes through the aerial reception range, the aerial reception range being a predetermined range in the space.

23. The contactless input device according to claim 22, wherein the processing circuitry uses a function predetermined such that output of the function that takes the low-delay smoothed three-dimensional operation coordinates as input is a predetermined value within the aerial reception range, and determines whether the instruction input object has passed through the aerial reception range.

24. The contactless input device according to claim 23, wherein the processing circuitry sequentially inputs multiple sets of the low-delay smoothed three-dimensional operation coordinates to the function, and when output of the function becomes larger or smaller than the predetermined value, the processing circuitry determines whether the instruction input object has passed through the aerial reception range.

25. A contactless input device comprising:
processing circuitry
to detect multiple sets of three-dimensional operation coordinates by sequentially detecting the three-dimensional operation coordinates, the three-dimensional operation coordinates being triaxial coordinates of an instruction input object in a predetermined space, the instruction input object being an object for inputting an instruction;
to calculate smoothed three-dimensional operation coordinates by performing smoothing by using a predetermined first number of sets of three-dimensional operation coordinates included in the multiple sets of three-dimensional operation coordinates, the first number being two or more; and
to use the multiple sets of three-dimensional operation coordinates to determine whether the instruction input object has passed through the aerial reception range, and to specify passage coordinates by using the smoothed three-dimensional operation coordinates, the passage coordinates being coordinates at which the instruction input object passes through an aerial reception range, the aerial reception range being a predetermined range in the space,
wherein when the instruction input object passes through the aerial reception range, the processing circuitry specifies a time point at which the instruction input object has passed through the aerial reception range, specifies the smoothed three-dimensional operation coordinates at the specified time point as the passage coordinates, and determines that input has been made to the aerial reception range when the passage coordinates are within the aerial reception range.

26. A contactless input device comprising:
processing circuitry
to detect multiple sets of three-dimensional operation coordinates by sequentially detecting the three-dimensional operation coordinates, the three-dimensional operation coordinates being triaxial coordinates of an instruction input object in a predetermined space, the instruction input object being an object for inputting an instruction;
to calculate smoothed three-dimensional operation coordinates by performing smoothing by using a predetermined first number of sets of three-dimensional operation coordinates included in the multiple sets of three-dimensional operation coordinates, the first number being two or more; and
to use the multiple sets of three-dimensional operation coordinates to determine whether the instruction input object has passed through the aerial reception range, and to specify passage coordinates by using the smoothed three-dimensional operation coordinates, the passage coordinates being coordinates at which the instruction input object passes through an aerial reception range, the aerial reception range being a predetermined range in the space,
wherein when the instruction input object passes through the aerial reception range, the processing circuitry specifies a time point at which the instruction input object has passed through the aerial reception range, specifies the smoothed three-dimensional operation coordinates at a delay time point later than the specified time point as the passage coordinates, and determines that input has been made to the aerial reception range when the passage coordinates are within the aerial reception range.

27. The contactless input device according to claim 26, wherein the delay time point is a time point obtained by adding, to the specified time point, time equal to or less than a delay time, the delay time being time for the processing circuitry to calculate the smoothed three-dimensional operation coordinates.

28. The contactless input device according to claim 27, wherein,
the processing circuitry performs the smoothing by using a linear phase filter, and
the delay time is a value of group delay of the linear phase filter.

29. The contactless input device according to claim 22, further comprising:
an output interface to perform output to outside of the contactless input device when the instruction input object passes through the aerial reception range.

30. The contactless input device according to claim 26, further comprising:
an output interface to perform output to outside of the contactless input device when the instruction input object passes through the aerial reception range,
wherein the output interface continues the output at least up to the delay time point.

31. The contactless input device according to claim 29, wherein the output comprises sound.

32. The contactless input device according to claim 29, wherein the output comprises ultrasonic waves that impart tactile sensation.

33. A contactless input device comprising:
processing circuitry
to detect multiple sets of three-dimensional operation coordinates by sequentially detecting the three-dimensional operation coordinates, the three-dimensional operation coordinates being triaxial coordinates of an instruction input object in a predetermined space, the instruction input object being an object for inputting an instruction;
to calculate smoothed three-dimensional operation coordinates by performing smoothing by using a predetermined first number of sets of three-dimensional operation coordinates included in the multiple sets of three-dimensional operation coordinates, the first number being two or more; and
to use the multiple sets of three-dimensional operation coordinates to determine whether the instruction input object has passed through the aerial reception range, and to specify passage coordinates by using the smoothed three-dimensional operation coordinates, the passage coordinates being coordinates at which the instruction input object passes through an aerial reception range, the aerial reception range being a predetermined range in the space,
wherein a threshold for detecting that the instruction input object has passed through the aerial reception range is set different from a threshold for detecting that the instruction input object has passed through the aerial reception range and then returned to the side before passing through the aerial reception range.

34. The contactless input device according to claim 22, further comprising:
an aerial-image projector to project, into the space, an aerial image having a portion associated with the aerial reception range.

35. The contactless input device according to claim 22, further comprising:
an image camera unit to output a three-dimensional image of the space including the aerial reception range,
wherein the processing circuitry detects the multiple sets of three-dimensional operation coordinates from the three-dimensional image.

36. The contactless input device according to claim 25, further comprising:
an image camera to output a three-dimensional image of the space including the aerial reception range,
wherein the processing circuitry detects the multiple sets of three-dimensional operation coordinates from the three-dimensional image.

37. The contactless input device according to claim 26, further comprising:
an image camera to output a three-dimensional image of the space including the aerial reception range,
wherein the processing circuitry detects the multiple sets of three-dimensional operation coordinates from the three-dimensional image.

38. The contactless input device according to claim 22, wherein the instruction input object comprises a finger.

39. The contactless input device according to claim 22, wherein the indicator input object comprises a protrusion.
